(19) United States
(12) Patent Application Publication
(10) Pub. No.: US 2026/0118420 A1
(43) Pub. Date: Apr. 30, 2026

(54) Systems, Methods, and Devices of Design-For-Test Circuitry

(71) Applicant: Arm Limited, Cambridge (GB)

(72) Inventors: Andy Wangkun Chen, Austin, TX (US); Shruti Aggarwal, Austin, TX (US)

(21) Appl. No.: 18/929,351

(22) Filed: Oct. 28, 2024

(51) Int. Cl. G01R 31/317

(52) U.S. Cl. CPC G01R 31/31704; G01R 31/31725

(57) ABSTRACT

A circuit for design-for-test (DFT)-mixing and internal clock pulse generation in test and functional modes includes a tristate inverter; a reset circuitry; and a clamp circuitry, where such clamp circuitry is configured for design-for-test (DFT)-mixing. A method for design-for-test DFT-mixing includes: in a test mode, providing a DFT information signal to a circuit; in response to receiving a clock signal at a clamp circuitry, retaining the DFT information signal at the clamp circuitry; and in response to a transition of the clock signal, deactivating the clamp circuitry and generating an internal clock pulse. A method for DFT-mixing includes: in a functional mode, providing, from a tristate inverter, a CTR signal on a critical path of a circuit; in response to an external clock signal, receiving at a logic circuitry coupled to the critical path, at least the CTR signal; and generating, by a first stage of the logic circuitry, an internal clock pulse.

### I. Field

The present disclosure is generally related to systems, methods, and devices of design-for-test (DFT) circuitry.

### II. Description of Related Art

In integrated circuit design, power efficiency and timing accuracy are critical factors. The chip enable (CEN) signal plays a crucial role in managing power consumption by controlling when specific circuit blocks or entire chips are active. However, the setup time associated with the CEN signal presents a persistent challenge in achieving optimal performance. CEN setup time refers to the minimum duration the CEN signal must be stable before the active clock edge. Excessive CEN setup time leads to several problems in circuit performance. It limits the maximum operating frequency, increases power consumption due to premature chip activation, and complicates timing closure across various operating conditions. Moreover, stringent CEN timing constraints restrict design flexibility and complicate the integration of pre-designed functional modules.

Previous attempts to address CEN setup issues have involved various approaches to signal distribution and circuit design. While these efforts have yielded incremental improvements, CEN setup time remains a significant bottleneck, particularly as process nodes shrink and chip speeds increase. The increasing demand for high-performance computing in artificial intelligence, data centers, and edge devices further emphasizes the need for efficient chip activation and control. Simultaneously, the growth of Internet of Things (IoT) devices heightens the importance of ultra-low power operation, making CEN optimization essential across a wide spectrum of applications.

Additionally, there is a growing need for improved capability in Design-for-Test (DFT) signal-mixing, particularly in the context of CEN setup time. This enhancement is crucial for ensuring precise control over test signal timing, optimizing circuit testability, and maintaining reliability across various operational modes. Effective DFT signal-mixing for CEN setup time allows for more accurate testing of timing-critical paths, better emulation of real-world conditions during test, and improved detection of subtle timing-related defects in chip activation and deactivation scenarios.

### III. Brief Description of The Drawings

The present technique(s) will be described further, by way of example, with reference to embodiments thereof as illustrated in the accompanying drawings. It should be understood, however, that the accompanying drawings illustrate only the various implementations described herein and are not meant to limit the scope of various techniques, methods, systems, circuits or apparatuses described herein.

FIG. 1 is a schematic diagram of an example circuit in accordance with various implementations described herein.

FIGS. 2A and 2B are waveform diagrams corresponding to FIG. 1 in accordance with various implementations described herein.

FIG. 3 is an operational method in accordance with various implementations described herein.

FIG. 4 is an operational method in accordance with various implementations described

FIG. 5 is a block diagram in accordance with various implementations described herein.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### IV. Detailed Description

Implementations of the present disclosure are described below with reference to the drawings. In the description, common features are designated by common reference numbers throughout the drawings.

In one implementation, the present disclosure describes a circuit for design-for-test (DFT)-mixing and internal clock pulse generation in test and functional modes. The circuit can include a tristate inverter, a reset circuitry and a clamp circuitry, where such clamp circuitry is configured for design-for-test (DFT)-mixing.

In another implementation, the disclosure describes a method for DFT-mixing and internal clock pulse (GTP) generation in a test mode. The method can include: 1) in a test mode, providing a DFT information signal to a circuit; 2) in response to receiving a clock signal at a clamp circuitry, retaining the DFT information signal at the clamp circuitry; and 3) in response to a transition of the clock signal, deactivating the clamp circuitry and generating an internal clock pulse.

In another implementation, the disclosure describes a method for DFT-mixing and internal clock pulse (GTP) generation in a functional mode. The method can include: 1) in a functional mode, providing, from a tristate inverter, a capture-test-response (CTR) signal on a critical path of a circuit; 2) in response to an external clock signal, receiving at a logic circuitry coupled to the critical path, at least the CTR signal; and 3) generating, by a first stage of the logic circuitry, an internal clock pulse (GTP).

Certain definitions have been provided herein for reference. The term “design-for-test (DFT) mixing” refers to a technique used in design for testability to enhance the testability and performance of signals. It involves combining and/or configuring for use both functional and test signals within the same circuitry components to optimize a circuit path. By doing so, the goal is to improve setup time without compromising testability. The term, CEN signal (CEN) (e.g., “chip-enable signal) is a control signal used to activate or deactivate a chip or a specific function within an integrated circuit. The CEN signal is a critical signal for power management and proper operation of the integrated circuit. The term “chip enable setup time” is a time required for the CEN signal to be stable before an active clock edge. The chip enable set up time is critical for proper operation of synchronous circuits. The term “slew” refers to the rate of change of a signal over time. In this context, it refers to how quickly the CEN signal transitions from one logic state to another. Too slow a slew rate may lead to undefined states or timing violations. Too fast a slew rate might cause ringing or overshoot, potentially triggering false enable/disable events. The term “CEN setup slew” refers to the rate at which the CEN signal changes during its setup period. It is usually measured in volts per nanosecond (V/ns) or similar units. The term “capture-test-response (CTR) signal” (CTR), also known as the DFT (Design for Testability) information signal, is a versatile tool in integrated circuit design and testing. In test mode, it captures and shifts out the circuit's state in response to applied stimuli, facilitating scan-based testing. In functional mode, the CTR signal can provide insights into normal circuit operation, capturing critical state transitions, timing-sensitive paths, and internal node behaviors. Advantageously, this dual-purpose signal serves as a crucial link between testing and real-world operation, offering valuable data for both manufacturing quality assurance and operational performance analysis. In certain implementations, as described herein, the CTR signal can be forced to a logic high state (e.g., VDD) to ensure a known, stable state for the CTR signal during certain test operations or modes, and prevent unwanted capture or to initialize the test circuitry. The term “Inverse Design-For-Test (NDFT) clock signal” (NDFTCLK) refers to a novel clock signal specifically designed for test purposes that would not interfere with normal functional operation. NDFTCLK can be used to enable testing of a circuit without altering its functional state. It further allows for observation of circuit behavior during test mode without disrupting normal operations. The term “global timing pulse (GTP) signal” (GTP) signal refers to a generated internal clock signal (e.g., internal clock pulse) for read and/or write memory operations.

As would be appreciated, the chip enable signal (CEN), the capture-test-response signal (CEN), and the global timing pulse (GTP) are interconnected signals central for the proper functioning and testing of modern integrated circuits. The chip enable signal (CEN) activates specific functional blocks or entire chips, setting the stage for normal operation or test modes. In test scenarios, the capture-test-response (CTR) signal initiates the recording of circuit states in response to test stimuli. The global timing pulse (GTP), derived from and synchronized with these signals, provides a uniform time reference across the chip, ensuring coherent operation during both functional and test modes. The intricate interplay between these signals is particularly evident in Design-for-Test (DFT) methodologies, where precise timing control is essential for accurate fault detection. The chip enable (CEN) signal's setup time directly influences the timing of the capture-test-response (CTR) signal, which in turn must be carefully coordinated with the global timing pulse (GTP) to ensure valid test results. Optimizing this relationship is critical for enhancing testability, improving fault coverage, and ultimately ensuring the reliability of complex integrated circuits across various operational conditions.

Inventive aspects of the present invention introduce an innovative ultra-high speed CEN setup DFT latch circuitry to optimize the relationship between the chip enable signal (CEN), the capture-test-response signal (CTR), and the global timing pulse (GTP). Such inventive aspects significantly improve CEN setup time by reducing the number of stages and/or devices needed in the critical path and by implementing advanced signal mixing techniques. A key advantage of this solution is the strategic placement of DFT-related components. For example, since DFT is a non-critical signal, it can be moved to a non-critical portion of the circuit, specifically the latch circuitry, instead of the critical path. Such an approach allows for optimized performance without compromising testability. Furthermore, the inventive aspects also provide novel methods and techniques for the operation of DFT signal-mixing within such DFT latch circuitry. These methods enable efficient integration of DFT functionality while maintaining the ultra-high speed performance of the CEN setup. Various techniques described herein provide innovative ways to multiplex and demultiplex DFT signals, manage signal timing within the latch, and ensure signal integrity during both functional and test modes of operation.

Advantageously, such inventive aspects achieve a CEN setup improvement of approximately 8 picoseconds compared to conventional approaches. This optimization is accomplished while enhancing other critical parameters, including internal slew rates, thereby contributing to faster signal transitions and improved timing margins. Furthermore, the inventive circuitry and methods described herein demonstrate robust performance across varying conditions, successfully passing Design-for-Variability (DV) testing at 70-30 and 60-40 ratios. In addition, the proposed aspects described herein address long-standing industry challenges, enabling higher clock frequencies, more precise power management, and greater design flexibility. Such aspects represent a significant advancement in CEN-related circuit design, with potential applications spanning from high-performance computing systems to energy-efficient mobile and IoT devices. Hence, by improving CEN setup performance and optimizing DFT integration, the inventive aspects pave the way for more efficient and higher-performing integrated circuits, aligning with the semiconductor industry's ongoing pursuit of improved speed, power efficiency, and reliability

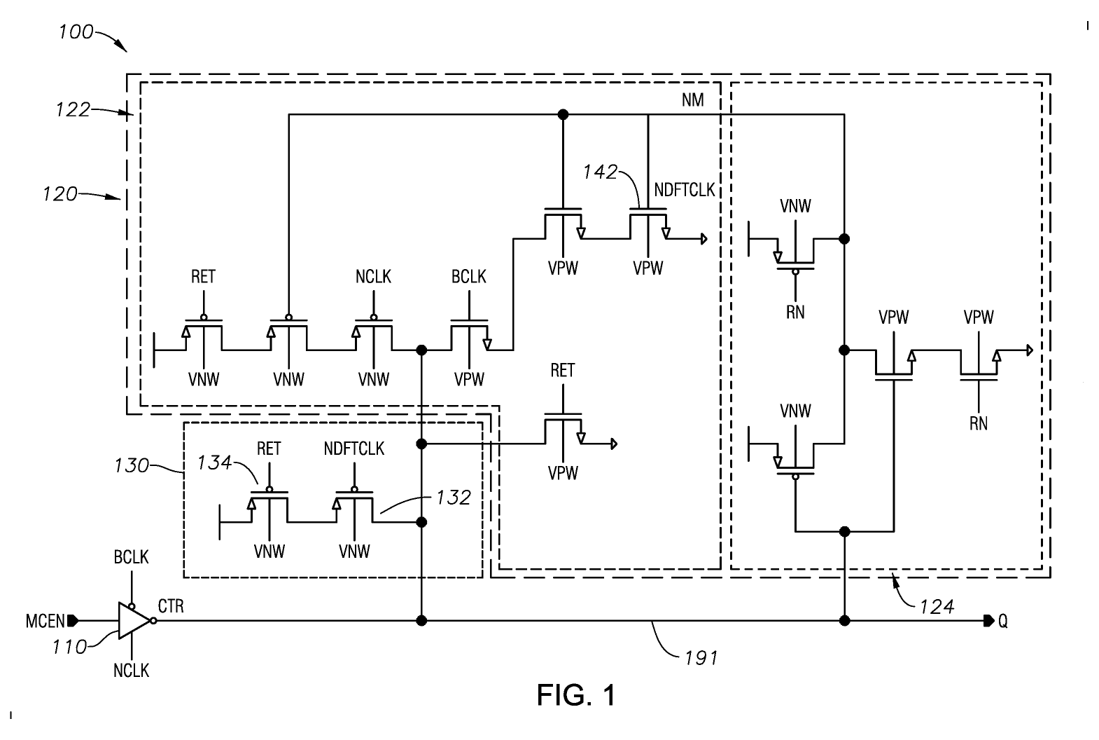

Referring to FIG. 1, a circuit 100 for design-for-test (DFT)-mixing according to example implementations is shown. As illustrated, the circuit 100 (e.g., a DFT-latch circuitry, a clock generation latch circuit, an internal clock pulse (e.g., global timing pulse (GTP)) generation circuitry) may include a single tristate inverter 110, a reset circuitry 120, and a clamp circuitry 130. In certain implementations, the clamp circuitry 130 include a DFT component, and is configured for DFT-mixing. For instance, DFT-mixing is the capacity for combining and/or configuring for use both functional and test signals within the same circuit components. Additionally, the reset circuitry 120 and clamp circuitry 130 in combination can be referred to as latch circuitry. Advantageously, such a circuit implementation may be used for various port configurations including, but not limited to: single-port memory, dual-port memory, two-port memory, or multi-port memory.

In certain instances, the tristate inverter 110 may be configured to receive a chip enable signal (e.g., middle CEN (MCEN) signal), a normal-clock signal (NCLK) and a bypass-clock signal (BCLK) to generate and output a capture-test-response (CTR) signal (e.g., DFT information signal). In various operations, the tristate inverter 110 can be configured to invert the MCEN signal, combine the CEN with clock information (e.g., NCLK and/or BCLK), select between normal and bypass clock domains based on the CEN state, provide tri-state capability for power saving or multi-source control, and generate a synchronized CTR signal that incorporates both enable and timing information.

In certain cases, the reset circuitry 120 includes a latch-holding circuitry 122 (e.g., a storage logic portion) and a NAND logic circuitry 124. As illustrated, the latch holding circuitry 122 includes an NMOS device 142. For example, the NMOS device 142 can be configured to receive an inverse-DFT (NDFT) clock signal. As may be appreciated, the NMOS device 142 can be configured to “mix” the NDFT clock signal. By doing so, advantageously, the circuit 100 can avoid a generated direct current (DC) path on the account of the first PMOS device 132 introduced in the clamp circuitry 130.

In certain implementations, the clamp circuitry 130 includes first and second PMOS devices 132, 134 (e.g., first and second PMOS transistors). According to various aspects, the clamp circuitry 130 is configured to retain (e.g., “clamp” or hold) a state of a capture-test-response (CTR) signal (e.g., DFT information signal) to a high state. For example, as explained in greater detail in below paragraphs, upon an NDFT clock signal assertion of a low state at the first PMOS device 132, the first PMOS device 132 is activated. Once activated, the clamp circuitry is “on”, and would retain the state of the CTR signal. Subsequently, upon an external clock (CLK) being asserted as high state, the first PMOS device 132 may be deactivated, and turning the clamp circuitry “off”. In certain aspects, the second PMOS transistor 134 is configured to receive a retention mode (RET) signal (e.g., in return mode). In one example, the RET signal can have a higher priority than DFT (e.g., DFTRAMBYP). Accordingly, even in if DFT is set high, in a RET mode, the RET signal would have a higher priority and disable the CTR signal (e.g., DFT information signal).

In some instances, the circuit 100 further includes logic circuitry (not shown) (e.g., one or more NAND gates) that is configured to receive a CTR signal (e.g., a DFT information signal) and an external clock signal (CLK), and generate an internal clock pulse (e.g. GPT) at a first stage of such logic circuitry. For example, such logic circuitry can be coupled to both the critical path 191 receiving the Q output and the NAND logic circuitry 124 at the feedback signal RN input.

Also, as shown in FIG. 1, for body biasing, VNW (N-well voltage) can be applied to the N-well or body terminal of each of the PFET devices of the circuit 100. Likewise, also for body biasing, VPW (P-well voltage) can be applied to the P-well or body terminal of each of the NFET devices of the circuit 100. In certain implementations, for example, a separate novel circuitry (e.g., NDFT clock generation circuitry) can be implemented to generate various clock signal such as: NDFTCLK, BCLK, and NCLK. For instance, in such circuitry, when DFT is asserted as high, the NDFT would go low, and that output would be “mixed” with an external clock signal (CLK) to create an NDFT clock signal (NDFTCLK) that is later input to the clamp circuitry 130 to serve as a control signal. In addition, such circuitry may also generate both BCLK and NCLK that is provided to the tristate inverter 110.

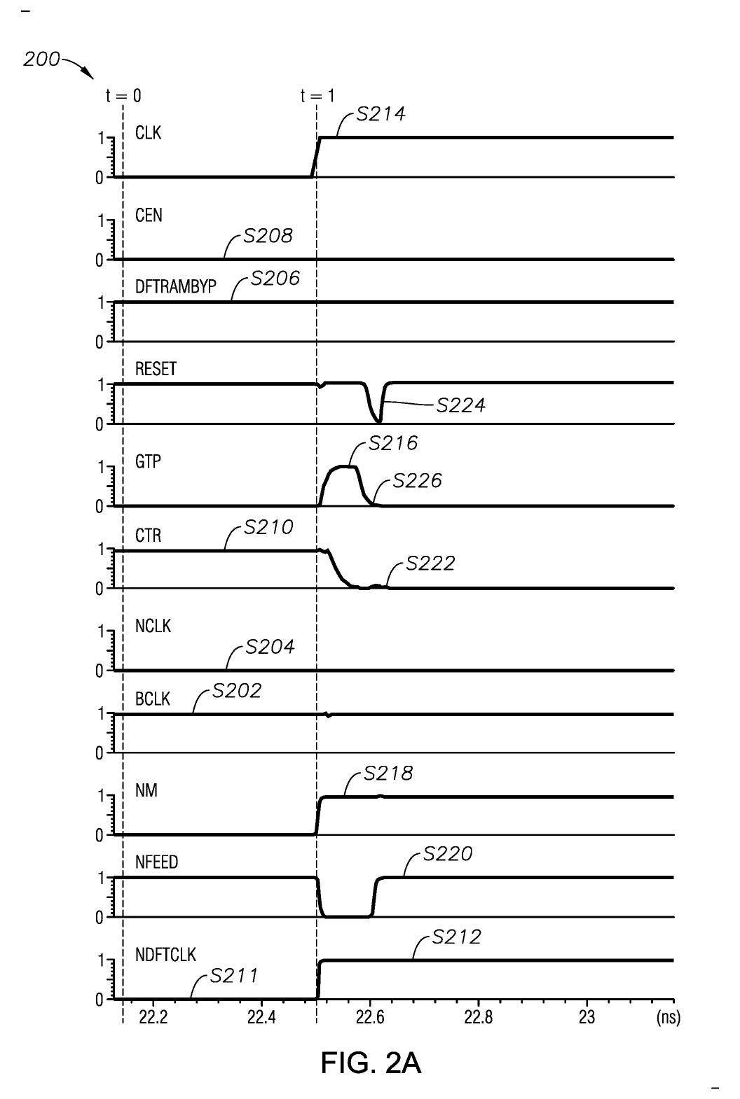

Referring to FIGS. 2A-2B, example operation sequences 200, 250 are shown corresponding to design-for-test (DFT) operations of the circuit 100. FIG. 2A illustrates one example DFT-test operation scenario sequence 200 (e.g., DFT = 1, “test mode”) discussed with reference to the DFT-latch circuitry 100 in FIG. 1. In an example operation, initially, at a first time interval (t=0), at the tristate inverter 110, the b-clock signal (BCLK) is turned “on” (e.g., voltage is set to a high state, BCLK is a digital high, “1”) (S202), the n-clock signal (NCLK) is asserted at a “low” state (e.g., a digital “0”) (S204), and DFT-ram-bypass (e.g., DFTRAMBYP) is also asserted at a high state (S206) (e.g., a digital “1”). Also, at the first time interval (t=0), the chip enable signal (CEN) (e.g., middle pin CEN) is asserted at a low state (S208). In various cases, CEN can be either a digital high or a digital low in test mode. For example, since the tristate inverter 110 is “off” (e.g., as BCLK and NCLK signals would block CEN propagation), the circuit 100 (via the clamp circuitry 130 through NDFTCLK) can assert CTR at a high state (S210). At this time as well (t=0), in response to the NDFT clock (NDFTCLK) (e.g., clamp signal) asserted as a low state (S211), the first PMOS device 132 of the clamp circuitry 130 is configured to retain the CTR (e.g., DFT information signal) (e.g., to initialize the state of the CTR to high) within the latch of the circuit 100 itself. Hence, because the circuit 100 operates as a latch, the high state of CTR would be retained unless a feedback reset signal (e.g., RN signal) arrives to make CTR low again. Concurrently, the capacity for GTP to be generated via the critical path 191 would be established. Advantageously, during the DFT mode, to test the memory, triggering GTP would be desired, In addition, as one example, in certain aspects, when CEN is at a high state, GTP cannot be generated.

Subsequently, at a second time interval (t=1), NDFT clock signal (NDFTCLK) is asserted as high (S212) and provided to the circuit 100 (e.g., at an input of the first PMOS device 132 of the clamp circuitry 130). In addition, at the second time interval (t=1), the external clock (CLK) is also asserted as high (S214). By doing so, the clamp circuitry 130 is “turned off”. In addition, because CTR (e.g., the DFT information signal) was previously asserted as high (at S210), the state of CTR is maintained high with the latch circuitry. Now, as CLK is also asserted as high (at S214), GTP would rise in voltage level (S216). When GTP reaches to an approximately 70% voltage threshold level (at S216), NM signal is generated (e.g., NM is asserted to high) (S218) to reset the circuit 100. Correspondingly, based on the NM signal asserted to high (at 218), NFEED signal goes high (S220), and is transmitted as the RN signal to the NAND gate 124 of the reset circuitry 120 (in FIG. 1). In this manner, for instance, when GTP goes high, RN is “triggered” to make CTR low. Advantageously, in this manner, due to the innovative NDFTCLK “clamping” the clamp circuitry 130 (e.g., PMOS device 132 is “off”), a reset path (nm path in FIG. 1) can be enabled to reset the CTR (e.g., the DFT information signal) (e.g., assert the CTR to a low state) (S222). Independently, a distinct reset signal, RESET can be asserted (S224) to disable GTP (S226). Accordingly, in such a manner, innovative designs of the present invention allow for the capacity for DFT-operation in the DFT-latch circuitry 100 of FIG. 1.

FIG. 2B illustrates one example functional operation scenario sequence 250 (e.g., DFT = 0, “functional mode”) discussed with reference to the DFT-latch circuitry 100 in FIG. 1. In an example operation, initially, at a first time interval (t=0), at the tristate inverter 110, BCLK is asserted at a low state (S252), NCLK is asserted at a high state (S254), and DFT-ram-bypass (e.g., DFTRAMBYP) is also asserted at a low state (S256). Also, at the first time interval (t=0), CEN is asserted at a low state (S258); and when CEN is at a low state, the circuit 100 (via the tristate inverter 110) will provide CTR at a high state (S260). Concurrently, the capacity for GTP to be generated via the critical path 191 would be established. As one example, in certain aspects, when CEN is at a high state, GTP cannot be generated. In addition, in the functional mode, in contrast to the test mode (as described with reference to FIG. 2A), at the first interval (t=0) as well as a second interval (t=1), NDFTCLK is continuously asserted at a high state (S262). In doing so, NDFTCLK is provided an input of the first PMOS device 132 of the clamp circuitry 130.

Subsequently, at a second time interval (t=1), NDFTCLK continues to be asserted as high (S262) and provided to the circuit 100. In addition, at the second time interval (t=1), the external clock (CLK) is also asserted as high (S264). By doing so, the clamp circuitry 130 is “turned off”. In addition, because CTR was previously asserted as high (at S260) and now CLK is also asserted as high (at S264), GTP would rise in voltage level (S266). When GTP reaches to an approximately 70% voltage threshold level (at S266), NM signal is generated (e.g., NM is asserted to high) (S268) to reset the circuit 100. Correspondingly, based on the NM signal asserted to high (at 268), NFEED signal goes high (S270), and is transmitted as the RN signal to the NAND gate 124 of the reset circuitry 120 (in FIG. 1). In this manner, for instance, when GTP goes high, RN is “triggered” to make CTR low. Advantageously, in this manner, due to NDFTCLK asserted high, the clamp circuitry 130 (e.g., the PMOS device 132 is “off”), a reset path (e.g. NM path via the NMOS device 142 in FIG. 1) can be enabled to reset the CTR (e.g., assert the CTR to a low state) (S272). Independently, a distinct reset signal, RESET can be asserted (S274) to disable GTP (S276).

Moreover, in advanced integrated circuit designs, optimizing signal routing and minimizing layout area are crucial for improving overall performance and reducing manufacturing costs. Accordingly, one novel approach in layout placement described herein involves connecting the middle chip enable (MCEN) pin to a tristate inverter input. This innovative configuration offers several advantages. 1) Enhanced Circuit Efficiency: By directly connecting the MCEN pin to a tristate inverter input, the design reduces the need for additional buffering or routing layers. This direct connection can lead to faster signal propagation and reduced power consumption. 2) Improved Signal Integrity: The proximity of the MCEN pin to the tristate inverter input minimizes the length of the signal path, potentially reducing noise susceptibility and signal degradation. 3) Optimized Routing: This placement strategy can simplify the overall routing scheme of the chip. By strategically positioning the MCEN pin, designers can potentially reduce the complexity of metal layers and vias required for signal distribution. 4) Area Reduction: The compact nature of this connection can contribute to a smaller overall footprint for the chip enable circuitry, allowing for more efficient use of silicon area. 5) Enhanced Testability: The direct connection to a tristate inverter can facilitate easier implementation of test modes, as the tristate functionality provides a convenient mechanism for isolating or controlling the chip enable signal during testing procedures. 6) Flexibility in Power Management: This configuration can offer more granular control over power domains, potentially allowing for more sophisticated power gating strategies. 7) Improved Timing Control: The proximity of the MCEN pin to the tristate inverter can lead to more predictable and manageable timing characteristics, which is crucial for high-speed operations and meeting stringent setup and hold time requirements

Furthermore, in various implementations, the layout strategy extends beyond the MCEN and tristate inverter connection. The MCEN pin can be strategically placed directly over the clock generation latch circuit, significantly reducing gating and routing complexities for both PMOS and NMOS transistors. This proximity minimizes routing distances, thereby reducing parasitic capacitances and resistances. As a result, signal integrity improves and propagation delays decrease.

The output of the tristate inverter (e.g., CTR) plays a crucial role in generating the global timing pulse (GTP) used for internal clock generation. This layout configuration creates a direct and efficient path for internal clock control. Concurrently, the NDFTCLK signal serves as an input to the DFT clamp, seamlessly integrating test functionality into the layout. Such an arrangement allows for efficient switching between functional and test modes, enhancing overall testability. The streamlined signal flow from MCEN input, through the tristate inverter, to the CTR signal, and finally to GTP for internal clock generation, thereby minimizing delays and improving timing characteristics. This compact and efficient layout not only saves valuable chip area but also leads to reduced power consumption due to shorter routing paths and optimized gating. Moreover, the close integration of DFT elements with core functionality enhances test coverage and efficiency, while the reduced routing distances minimize the risk of signal degradation and crosstalk.

Advantageously, this novel layout placement represents a significant advancement in circuit design techniques, particularly for systems requiring precise control of chip enable functionality. By leveraging the unique properties of tristate inverters and optimizing the physical placement of the MCEN pin, designers can achieve a more efficient and robust integrated circuit architecture. This innovative layout strategy demonstrates an integrated approach to circuit design, effectively balancing performance, power efficiency, testability, and chip reliability. Furthermore, such an approach can scale well with advancing process nodes.

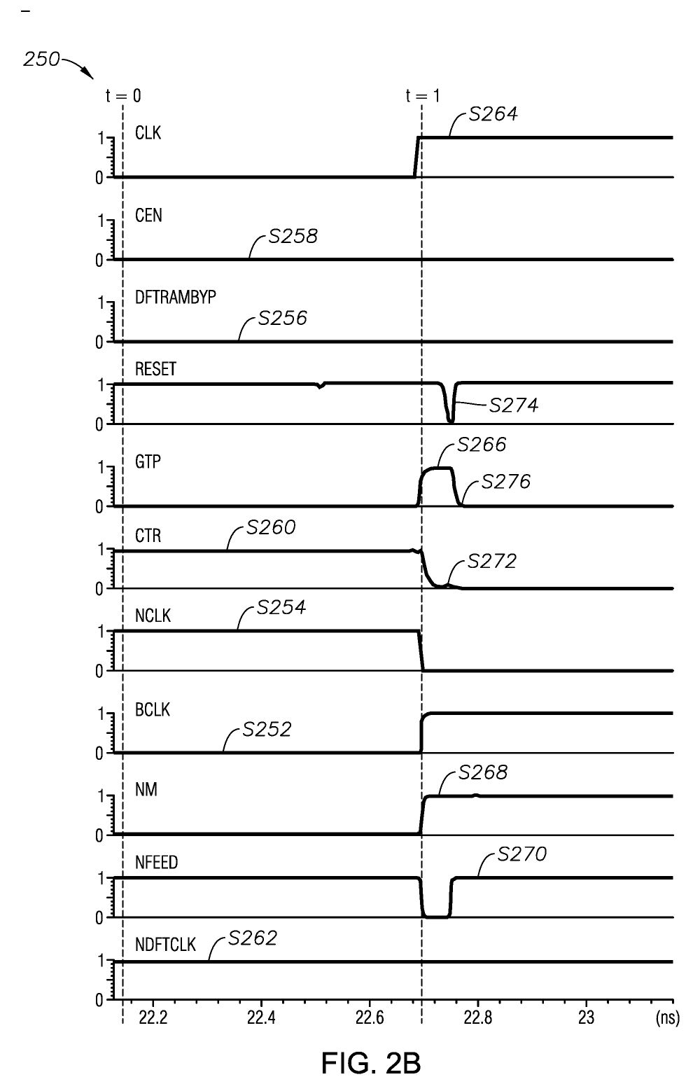

Referring to FIG. 3, a flowchart of an example operational method 300 (i.e., procedure) is shown. Advantageously, in various implementations, the method 300 describes the capability of design-for-test (DFT) signal mixing by the circuit 100 in a test mode (e.g., DFT=1). The method 300 may be implemented with reference to circuit implementation as shown in FIGS. 1 and 2A.

At block 310, the example method 300 includes: in a test mode, providing a DFT information signal to a circuit. For instance, as described with reference to FIGS. 1-2A, in a test mode (e.g., DFT=1), a DFT information signal (e.g., CTR) is provided to a DFT-latch circuit 100.

At block 320, the example method 300 includes: in response to receiving a clock signal at a clamp circuitry, retaining the DFT information signal at the clamp circuitry of the circuit. For instance, as described with reference to FIGS. 1 and 2A, in response to receiving a clock signal (NDFTCLK) at a clamp circuitry 130 of the circuit 100, retaining the DFT information signal (e.g., CTR) at the clamp circuitry 130.

At block 330, the example method 300 includes: in response to a transition of the clock signal, deactivating the clamp circuitry and generating an internal clock pulse. For instance, as described with reference to FIGS. 1 and 2A, in response to a transition of the clock signal (e.g., CLK going high at S214, t=1), the clamp circuitry 130 is deactivated and an internal clock pulse GTP is generated.

In certain implementations, the clock signal is an inverse design-for-test clock signal (NDFT). In certain cases, the example method 300 further includes, in response to the deactivation of the clamp circuitry 130, a feedback signal (RN) (e.g., a reset signal) is generated. Also, a reset circuitry 120 of the circuit 100 is configured to reset the DFT information signal (e.g., CTR) at the clamp circuitry 130 based on the generated feedback signal (RN).

In some instances, the generation of the feedback signal (RN) includes: providing, at a logic circuitry (not shown) (e.g., one or more NAND gates) of the circuit 100 coupled to the reset circuitry 120, the DFT information signal (e.g., CTR, Q-output) and an external clock signal (CLK). Also, in such instances, the generation of the feedback signal (RN) includes: generating, by a first stage of the logic circuitry, the internal clock pulse (GTP) and the generating, by a second stage of the logic circuitry, a feedback signal (RN) based at least partially on the internal clock pulse (GTP).

In certain implementations, the internal clock pulse corresponds to a global timing pulse (GTP). In various aspects, the generation of the internal clock pulse includes: 1) providing, at a logic circuitry (not shown) (e.g., one or more NAND gates) of the circuit 100 coupled to the reset circuitry 120, the DFT information signal (e.g., CTR, Q-output) and an external clock signal (CLK); and 2) generating, by a first stage of the logic circuitry, the internal clock pulse (GTP). In some cases, the method 300 further includes: deactivating, by a tristate inverter 110 of the circuit 100, a chip-enable (CEN) signal.

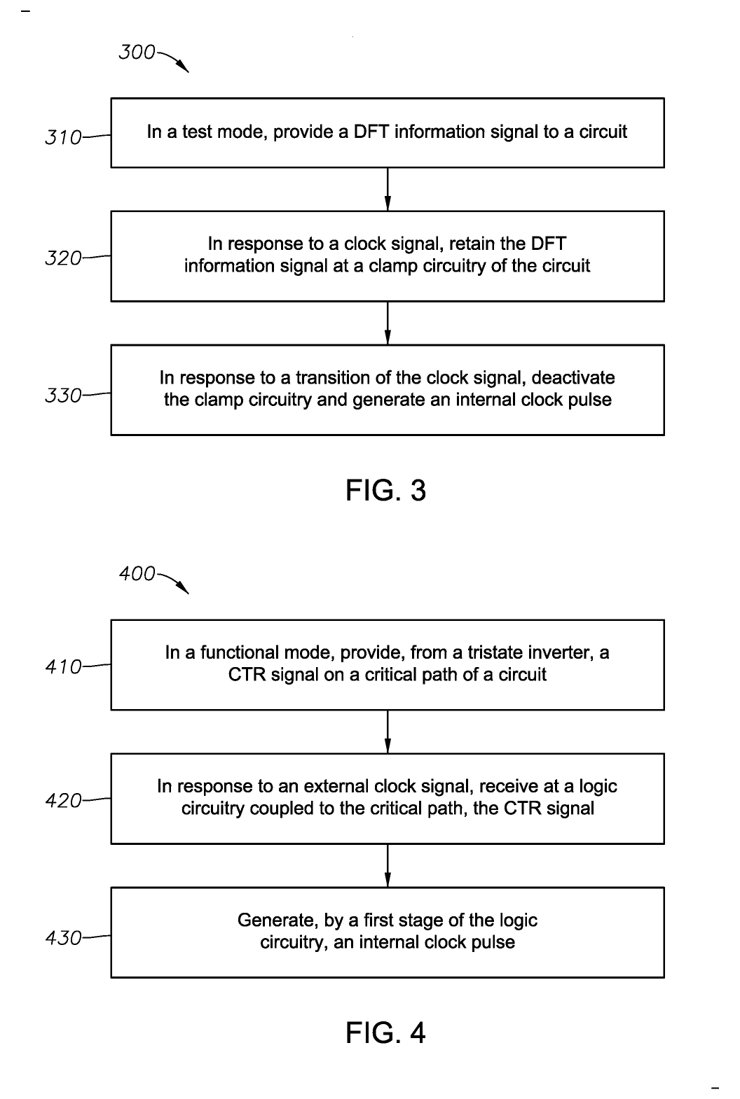

Referring to FIG. 4, a flowchart of an example operational method 400 (i.e., procedure) is shown. Advantageously, in various implementations, the method 400 describes the capability of design-for-test (DFT) signal mixing by the circuit 100 in a functional mode (e.g., DFT=0). The method 400 may be implemented with reference to circuit implementation as shown in FIGS. 1 and 2B.

At block 410, the example method 400 includes: in a functional mode, providing, from a tristate inverter, a capture-test-response (CTR) signal on a critical path of a circuit. For instance, as described with reference to FIGS. 1 and 2B, in a functional mode (e.g., DFT=0), a CTR signal is provided on a critical path 191 of a circuit 100 from a tristate inverter 110.

At block 420, the example method 400 includes: in response to an external clock signal, receiving at a logic circuitry coupled to the critical path, CTR signal. For instance, as described with reference to FIGS. 1 and 2B, in response to an external clock signal, the CTR signal is received at a logic circuitry (not shown) coupled to the critical path 191. In certain implementations, an external clock signal (CLK) may also be provided to the logic circuitry.

At block 430, the example method 400 includes: generating, by a first stage of the logic circuitry, an internal clock pulse. For instance, as described with reference to FIGS. 1 and 2B, an internal clock pulse (GTP) is generated by a first stage of the logic circuitry (not shown). In certain implementations, the internal clock pulse (GTP) may be generated based on the CTR signal and the external clock signal (CLK).

In certain aspects, the example method 400 further includes: 1) generating, by a second stage of the logic circuitry (not shown), a feedback signal (e.g., RN signal); and 2) in response to a feedback signal, transitioning the CTR signal from a logical high state to a logic low state. In some cases, the transitioning of the CTR signal includes reducing the voltage level of the CTR signal from a first voltage potential to a second voltage potential, where the second voltage potential is lower than the first voltage potential.

Also, according to aspects of certain operational methods, an output may be generated based on the operational dispositions. For example, with reference to various implementations as described in FIGS. 1 and 2A-2B, an output (i.e., a DFT-latch design/ internal clock pulse (GTP) generation design in DFT mode/ DFT signal-mixing in latch circuitry) may be generated. For instance, certain method steps can include: providing a tristate inverter; providing a reset circuitry; and providing a clamp circuitry, where the clamp circuitry is configured for design-for-test (DFT)-mixing. In some implementations, the electronic design automation (EDA) tool 524 (e.g., incorporating a circuit design tool) may allow users to input certain values, and generate circuit designs incorporating the inventive DFT-latch circuitry design/ internal clock pulse (GTP) generation circuitry in DFT mode/ DFT signal-mixing. Such a tool 524 may be focused on the creation, analysis, and verification of such electronic circuits.

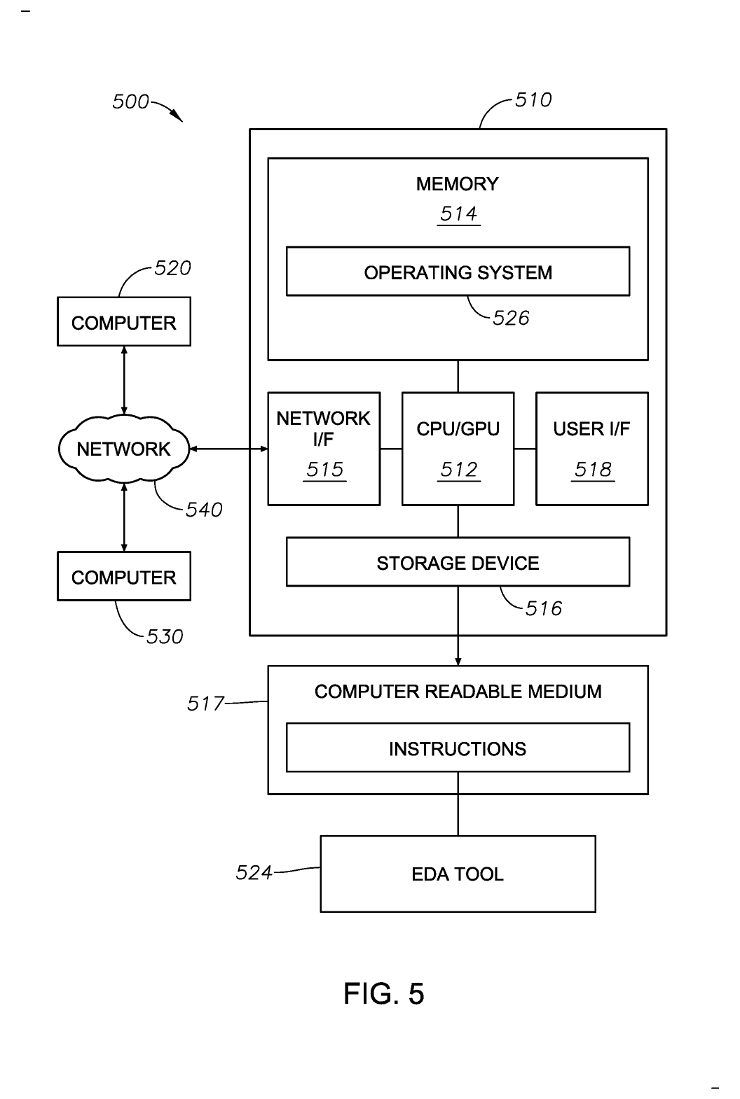

FIG. 5 illustrates example hardware components in the computer system 500 that may be used to facilitate and generate the inventive design-for-test (DFT)-mixing circuit design/memory architecture output. In certain implementations, the example computer system 500 (e.g., networked computer system and/or server) may include EDA tool 524 and execute software based on the procedure as described with reference to the methods as described herein.

For instance, the EDA tool 524 can generate the inventive DFT-latch circuit designs, as described herein, through a series of automated steps and design modifications. In certain cases, the tool 524 would begin by analyzing an existing circuit design, particularly focusing on the CEN signal path and its interaction with clock generation circuitry. By doing so, it would identify the key components involved in normal operation and determine how to modify them to support both functional and test modes. Further, in generating such circuit designs, the EDA tool 524 can insert additional logic around the CEN signal path, as described herein. In some cases, this might involve creating a multiplexed input for various signals, allowing for control either by normal chip operations or by test inputs. The tool 524 would design latching mechanisms to capture the CTR signal state at specific times, as described herein, enabling predictable behavior during test mode. To generate the internal clock pulse (GTP), the EDA tool 524 would create designs , as described herein, that combines the latched CTR signal with existing and generated clock signals. In addition, the tool 524 would ensure that the resulting pulse can be precisely controlled and synchronized with other test operations.

Throughout such processes, the EDA tool 524 would automatically handle complex timing considerations. It would have the capability to analyze and adjust signal paths to maintain proper timing relationships, potentially inserting buffers or adjusting gate sizes to meet setup and hold time requirements for the innovative DFT circuitry. The tool 524 would also generate the necessary control signals for managing the DFT features, such as scan enable signals or test mode selectors. It would integrate these into the existing design, ensuring they are properly distributed and do not interfere with normal chip operation. Moreover, the EDA tool 524 would verify the new circuitry through simulation and timing analysis, generate test patterns to exercise the DFT features, and produce documentation detailing the changes made and how to utilize the new test capabilities. Advantageously, such an automated approach allows for the efficient implementation of complex test structures while maintaining the integrity of the original design functionality.

Using the procedures 300 and 400, the EDA tool 524 may provide generated computer-aided physical layout designs for DFT-latch and GTP signal generation circuitry and/or memory architecture. The procedures 300 and 400 may be stored as program instructions as instructions 517 in the computer readable medium of the storage device 516 (or alternatively, in memory 514) that may be executed by the computer 510, or networked computers 520, 530, other networked electronic devices (not shown) or a combination thereof. In certain implementations, each of the computers 510, 520, 530 may be any type of computer, computer system, or other programmable electronic device. Further, each of the computers 510, 520, 530 may be implemented using one or more networked computers, e.g., in a cluster or other distributed computing system.

In certain implementations, the system 500 may be used with semiconductor integrated circuit (IC) designs that contain all standard cells, all blocks or a mixture of standard cells and blocks. In a particular example implementation, the system 500 may include in its database structures: a collection of cell libraries, one or more technology files, a plurality of cell library format files, a set of top design format files, one or more Open Artwork System Interchange Standard (OASIS/ OASIS.MASK) files, and/or at least one EDIF file. The database of the system 700 may be stored in one or more of memory 514 or storage devices 516 of computer 510 or in networked computers 520, 530.

In one implementation, the computer 500 includes a central processing unit (CPU) 512 having at least one hardware-based processor coupled to a memory 514. The memory 514 may represent random access memory (RAM) devices of main storage of the computer 510, supplemental levels of memory (e.g., cache memories, non-volatile or backup memories (e.g., programmable or flash memories)), read-only memories, or combinations thereof. In addition to the memory 514, the computer system 500 may include other memory located elsewhere in the computer 510, such as cache memory in the CPU 512, as well as any storage capacity used as a virtual memory (e.g., as stored on a storage device 516 or on another computer coupled to the computer 510).

The computer 510 may further be configured to communicate information externally. To interface with a user or operator (e.g., a circuit design engineer), the computer 510 may include a user interface (I/F) 518 incorporating one or more user input devices (e.g., a keyboard, a mouse, a touchpad, and/or a microphone, among others) and a display (e.g., a monitor, a liquid crystal display (LCD) panel, light emitting diode (LED), display panel, and/or a speaker, among others). In other examples, user input may be received via another computer or terminal. Furthermore, the computer 510 may include a network interface (I/F) 515 which may be coupled to one or more networks 540 (e.g., a wireless network) to enable communication of information with other computers and electronic devices. The computer 560 may include analog and/or digital interfaces between the CPU 512 and each of the components 514, 515, 516, and 518. Further, other non-limiting hardware environments may be used within the context of example implementations.

The computer 510 may operate under the control of an operating system 526 and may execute or otherwise rely upon various computer software applications, components, programs, objects, modules, data structures, etc. (such as the programs associated with the procedures 300, 400 and related software). The operating system 528 may be stored in the memory 514. Operating systems include, but are not limited to, UNIX® (a registered trademark of The Open Group), Linux® (a registered trademark of Linus Torvalds), Windows® (a registered trademark of Microsoft Corporation, Redmond, WA, United States), AIX® (a registered trademark of International Business Machines (IBM) Corp., Armonk, NY, United States) i5/OS® (a registered trademark of IBM Corp.), and others as will occur to those of skill in the art. The operating system 526 in the example of FIG. 5 is shown in the memory 514, but components of the aforementioned software may also, or in addition, be stored at non-volatile memory (e.g., on storage device 516) and/or the non-volatile memory (not shown). Moreover, various applications, components, programs, objects, modules, etc. may also execute on one or more processors in another computer coupled to the computer 510 via the network 540 (e.g., in a distributed or client-server computing environment) where the processing to implement the functions of a computer program may be allocated to multiple computers 520, 530 over the network 540. In example implementations, circuit related diagrams have been provided in FIGS. 1-5, whose redundant description has not been duplicated in the related description of analogous circuit related diagrams. It is expressly incorporated that the same diagrams with identical symbols and/or reference numerals are included in each of embodiments based on its corresponding figure(s).

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and procedural programming languages, such as the “C” programming language or similar programming languages. The computer-readable program instructions may execute entirely on the user's computer, partly on the user’s computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, a special purpose computer, or other programmable data processing apparatus to produce a machine, such that the instructions, which execute via the processor of the computer or other programmable data processing apparatus. The machine is an example of means for implementing the functions/acts specified in the flowchart and/or block diagrams. The computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the functions/acts specified in the flowchart and/or block diagrams.

The computer-readable program instructions may also be loaded onto a computer, other programmable data processing apparatus, or other device to cause a series of operational steps to be performed on the computer, other programmable apparatus or other device to perform a computer implemented process, such that the instructions which execute on the computer, other programmable apparatus, or other device implement the functions/acts specified in the flowchart and/or block diagrams.

The flowchart and block diagrams in the Figures illustrate the architecture, functionality, and operation of possible implementations of systems, methods, and computer program products according to various implementations of the present disclosure. In this regard, each block in the flowchart or block diagrams may represent a module, segment, or portion of instructions, which comprises one or more executable instructions for implementing the specified logical function(s). In some alternative implementations, the functions noted in a block in a diagram may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems that perform the specified functions or acts or carry out combinations of special purpose hardware and computer instructions.

In the following description, numerous specific details are set forth to provide a thorough understanding of the disclosed concepts, which may be practiced without some or all of these particulars. In other instances, details of known devices and/or processes have been omitted to avoid unnecessarily obscuring the disclosure. While some concepts will be described in conjunction with specific examples, it will be understood that these examples are not intended to be limiting.

Unless otherwise indicated, the terms “first”, “second”, etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

Reference herein to “one example” means that one or more feature, structure, or characteristic described in connection with the example is included in at least one implementation. The phrase “one example” in various places in the specification may or may not be referring to the same example.

Illustrative, non-exhaustive examples, which may or may not be claimed, of the subject matter according to the present disclosure are provided below. Different examples of the device(s) and method(s) disclosed herein include a variety of components, features, and functionalities. It should be understood that the various examples of the device(s) and method(s) disclosed herein may include any of the components, features, and functionalities of any of the other examples of the device(s) and method(s) disclosed herein in any combination, and all such possibilities are intended to be within the scope of the present disclosure. Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples illustrated and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims. Accordingly, parenthetical reference numerals in the appended claims are presented for illustrative purposes only and are not intended to limit the scope of the claimed subject matter to the specific examples provided in the present disclosure.

What is claimed is:

1. A circuit comprising:
a tristate inverter;
a reset circuitry; and
a clamp circuitry, wherein the clamp circuitry is configured for design-for-test (DFT)-mixing.

2. The circuit of claim 1, wherein the DFT-mixing corresponds to at least one of combining or configuring for use both functional and test signals.

3. The circuit of claim 1, wherein:
the clamp circuitry comprises first and second PMOS devices; and
the clamp circuitry is configured to retain a design-for-test (DFT) information signal at a logic high state.

4. The circuit of claim 3, wherein:
the first PMOS transistor is configured to receive a clamp control signal; and
the second PMOS transistors is configured to receive a retention mode signal.

5. The circuit of claim 1, wherein the reset circuitry comprises:
a latch-holding circuitry, and
a NAND logic circuitry.

6. The circuit of claim 5, wherein the latch-holding circuitry comprises an NMOS device.

7. The circuit of claim 6, wherein:
the NMOS device is configured to receive an inverse design-for-test (NDFT) clock signal to prevent a direct current path between the reset circuitry and a first PMOS device of the clamp circuitry.

8. The circuit of claim 1, wherein:
the clamp circuitry is configured to receive a clamp control signal, and
the clamp control signal corresponds to an inverse design-for-test (NDFT) clock signal.

9. The circuit of claim 1, wherein the tristate inverter is configured to receive a chip-enable (CEN) signal.

10. The circuit of claim 1, wherein the circuit is configured to generate an internal global timing pulse.

11. A method comprising:
in a test mode, providing a DFT information signal to a circuit;
in response to receiving a clock signal at a clamp circuitry of the circuit, retaining the DFT information signal at the clamp circuitry; and
in response to a transition of the clock signal, deactivating the clamp circuitry and
generating an internal clock pulse.

12. The method of claim 11, wherein:
the internal clock pulse is based at least partially on the DFT information signal; and
the clock signal is an inverse design-for-test clock signal.

13. The method of claim 11, further comprising:
in response to the deactivation of the clamp circuitry, generating a feedback signal; and
resetting, by a reset circuitry of the circuit coupled to the clamp circuitry, the DFT information signal at the clamp circuitry based on the generated feedback signal.

14. The method of claim 13, wherein generating the feedback signal comprises:
providing, at a logic circuitry of the circuit coupled to the reset circuitry, the DFT information signal and an external clock signal; and
generating, by a first stage of the logic circuitry, the internal clock pulse; and generating, by a second stage of the logic circuitry, a feedback signal based at least partially on the internal clock pulse.

15. The method of claim 11, wherein the internal clock pulse corresponds to a global timing pulse (GTP).

16. The method of claim 11, wherein generating the internal clock pulse comprises:
providing, to a logic circuitry of the circuit coupled to the reset circuitry, the DFT information signal and an external clock signal; and
generating, by a first stage of the logic circuitry, the internal clock pulse.

17. The method of claim 11, further comprising:
deactivating, by a tristate inverter of the circuit, a chip-enable (CEN) signal.

18. A method comprising:
in a functional mode, providing, from a tristate inverter, a capture-test-response (CTR) signal on a critical path of a circuit;
in response to an external clock signal, receiving at a logic circuitry coupled to the critical path, at least the CTR signal; and
generating, by a first stage of the logic circuitry, an internal clock pulse.

19. The method of claim 18, further comprising:
generating, by a second stage of the logic circuitry, a feedback signal; and
in response to the feedback signal, transitioning the CTR signal from a logical high state to a logic low state.

20. The method of claim 19, wherein transitioning the CTR signal comprises reducing the voltage level of the CTR signal from a first voltage potential to a second voltage potential.
